(19) United States
(12) Patent Application Publication
(10) Pub. No.: US 2009/0039165 A1
(43) Pub. Date: Feb. 12, 2009

(54) Methods and Apparatus for a Bar Code Scanner Providing Video Surveillance

(75) Inventors: Donald Alexander Collins, Jr., Buford, GA (US); Kenneth Joseph Fabian, Grayson, GA (US)

Correspondence Address: PAUL W. MARTIN, NCR CORPORATION, LAW DEPT., 1700 S. PATTERSON BLVD., DAYTON, OH, 45479-0001, US

(73) Assignee: NCR Corporation, Dayton, OH (US)

(21) Appl. No.: 11/835,578

(22) Filed: Aug. 8, 2007

(51) Int. Cl. G06K 7/10

(52) U.S. Cl. 235/462.41

(57) ABSTRACT

Systems and techniques for monitoring checkout transactions using video supplied by a camera integrated into a scanner used at a checkout station. The provides a view of an area of interest, and video is supplied to one or more remote locations, such as a security station or a product identification assistance station. An employee at a security station monitors a video stream transmitted to the station. When a product is entered into a transaction, a still frame of the video stream may be transmitted, suitably integrated with retrieved product information associated with the product. The employee may issue an alert on detecting an anomaly. An employee at an assistance station may be signaled by a user as needed, and may view video supplied to the assistance station to identify a product. The product identification may be supplied to the user, who may then make a transaction entry.

### FIELD OF THE INVENTION

The present invention relates generally to improvements to retail checkout verification. More particularly, the invention relates to improved systems and techniques for a retail checkout scanner providing video surveillance capability.

### BACKGROUND OF THE INVENTION

Retail checkout operations, particularly in high volume operations, typically face a number of obstacles to accurate and efficient checkout. One particularly important problem is the need to detect and combat theft, both by customers and by employees, who may or may not be working together with customers. Another problem is the need to assist customers or employees who may have difficulty in identifying a particular product, such as a particular variety of fruit, so that an accurate transaction entry can be made for the product. If the person conducting a checkout cannot quickly identify the product, calling for assistance is often time consuming and irritating both to the customer making the purchase and to other customers waiting in line.

In order to prevent theft, and to assist customers and employees in identifying products, it is useful to be able to see the product that is being presented at the checkout station. Many retailers maintain security and customer assistance personnel to monitor transactions and to provide assistance, but the attention of these personnel is frequently split among various customers and functions. Retail thieves use numerous ruses and techniques to avoid detection, and may appear to be presenting a product for purchase in a normal way, while they are in fact employing subterfuge to avoid making a transaction entry for the product being taken. A thief may, for example, cover a bar code on a more expensive product with one taken from a less expensive product, may conceal a more expensive product behind a less expensive product while the less expensive product is being scanned, or may employ any number of other techniques. A person delegated to assist customers in identifying products typically needs to be near the customers who may need assistance, and may not have information ready to hand to identify each unknown product that may be presented.

### SUMMARY OF THE INVENTION

The present invention addresses these problems, as well as others, by capturing a video feed of the vicinity of a checkout station, and using the video feed in any of a number of ways, including theft prevention and customer assistance. A scanner according to an aspect of the present invention may include an integrated camera operative to capture video of an object in a scan zone of the scanner. The video may be supplied as a video stream to any of a number of specified locations. For example, a video stream may be provided to a security station in a nearby or remote location. As transaction entries are made, the product in the transaction entry may be identified and an image of the product may be provided as an inset in the image of the actual product being presented, for comparison by a security employee. As each transaction entry is made, a still image of the video stream may be captured and stored. Image recognition may be performed to identify situations in which a product enters the scan zone but no transaction entry is made.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a checkout system according to an aspect of the present invention; and

FIGS. 2A-2C illustrate a process of checkout transaction processing and verification according to an aspect of the present invention.

### DETAILED DESCRIPTION

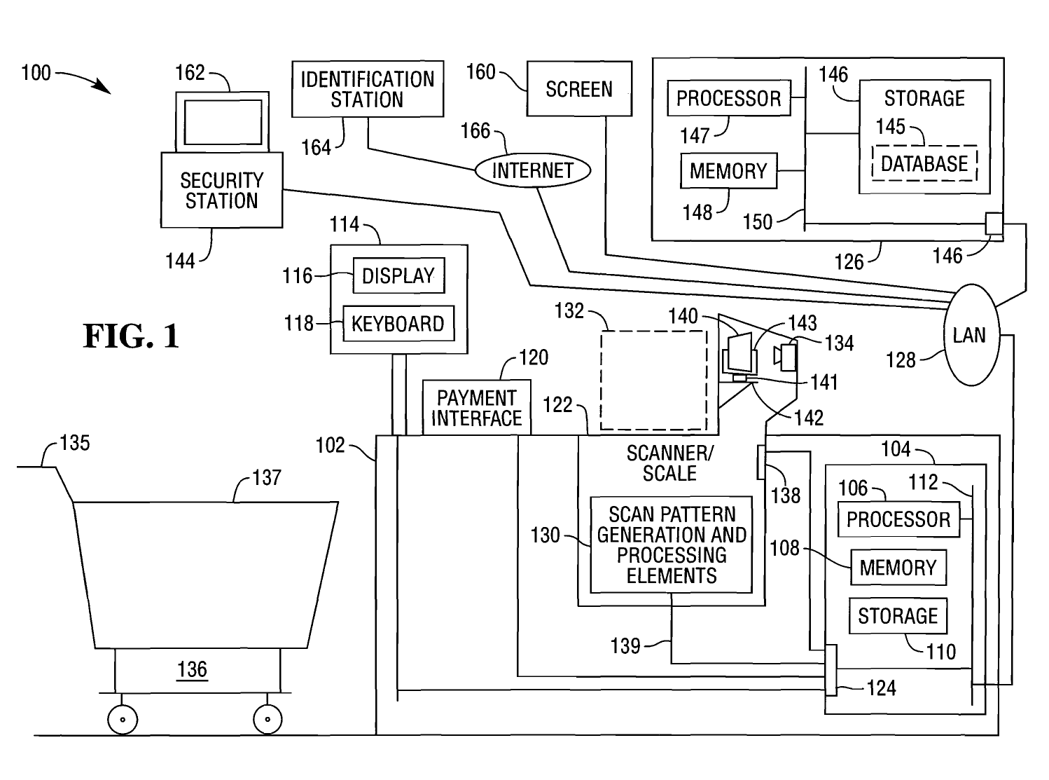

FIG. 1 illustrates a checkout system 100 according to an aspect of the present invention. The system 100 includes a checkout station 102, serving as a point of sale terminal. The checkout station 102 includes a computer 104. The computer 104 may suitably include a processor 106 having access to software to perform the operations described herein, high speed memory 108, and long term storage 110, all communicating over a bus 112. The terminal 102 may employ a user interface 114, including a keyboard 116 and display screen 118. The user interface 114, as well as a payment interface 120, and scanner/scale combination 122, communicate with the computer 104 through one or more interface connections, such as the interface 124. The interface 124 may suitably be a set of universal serial bus (USB) ports, a combination of USB ports and other types of ports, or any other suitable combination of communication connectors. The computer 104 may communicate with a central server 126 over a local area network 128.

The scanner/scale combination 122 includes scan pattern generation and processing elements 130, for generating a scan pattern comprising tracings of a scan beam onto an object presented within a scan zone 132 of the scanner/scale 122. The scanner/scale combination 122 also includes a camera 134, operative to provide a view of whatever area is desired, for example, the scan zone 132. The camera 134 may be integrated into the scanner/scale 122, and may be designed so as to be adjustable. For example, the camera 134 may be able to be tilted or panned, or its field of view may be adjusted so as to zoom in or out. Control may be performed under manual control of a viewer at a remote location, or may be conducted under the control of the computer 104. Alternatively, the camera 134 may be in a static position, but may be controlled so as to switch between fields of view, such as wide, medium, and narrow, so as to capture both a comprehensive view of the area of the checkout station 102 and a detailed view of an object within the scan zone 132. In particular, the camera 134 may be moved and adjusted so as to provide views of areas that are not in the scan zone 132, and in which a dishonest customer or employee may seek to conceal items from the view of security devices. For example, the camera 134 may provide a view of a shopping cart 135, or the area 136 under the basket 137 of the shopping cart 135.

The camera 134 suitably produces a video feed that can be relayed from the scanner 122, through a universal serial bus (USB) connection 138 provided to connect the scanner 122 to a host device such as the computer 104, for example through the interface 124. Depending on the design of the scanner 122, the camera 134 may have its own connection 138 with the computer 104, or alternatively may share a connection 139 with the scan pattern generation and processing elements 130. As noted above, the camera 134 may be movable so as to capture different views and perspectives of objects within its field of view, and the field of view of the camera 134 may also be varied. In addition or as an alternative, a rotating or otherwise moving mirror 140 may be provided, allowing the camera 134 to capture a changing field of view without a need to move the camera 134 itself, or combining with movement of the camera 134 to provide a greater variation in field of view. The mirror 140 may be supported on a platform 141, and may be mounted on a rotating pedestal 142. If desired, the mirror 140 may be mounted in a yoke assembly 143, providing an ability to pivot. Such an ability to pivot is useful in providing fields of view nearer to and farther from the camera 134, and helps to provide an ability to view areas that would otherwise be obscured by portions of the checkout station 102, such as the shopping cart 135, or objects that may be secreted just beyond the checkout station 102. The camera 134 can be configured to focus on the view provided by the mirror 140, and this view will change as the mirror 140 rotates.

As the checkout process proceeds, the camera 134 generates a video stream, which may be directed to any location desired, such as a security station 144. The video stream is supplied to the connection port 138, if present, the connection port 139, or both, and at the same time the scanner output is supplied to the connection port 139. The scanner/scale output, typically bar code and weight information, is supplied to the computer 104, which uses the bar code information to identify products and to perform other identification, such as user loyalty cards, perform price lookups, calculate prices, and make transaction entries. The computer 104 suitably communicates with the central server 126 to retrieve product information, which may suitably be stored in a product information database 145 stored in long term storage 146 on the server 126. The server 126 may also suitably employ a processor 147 and memory 148, communicating over a bus 150 with the long term storage 146, in order to retrieve the information in the database 145, as well as other information, and perform other functions under the control of software suitably hosted on the long term storage 146 and transferred to memory 148 for execution by the processor 147 as needed.

As the computer 104 receives bar code information and performs product identification, it can convey product information to the security station 140 along with the video stream. The video stream and the product identification information can be supplied to the security station 140 simultaneously. For example, a window including the name and a photo of the product whose information has been entered may appear as an insert in the display of the video stream showing the actual object in the scan zone 132. Suitably, a still frame of the video stream may be captured when a transaction entry occurs.

Such a procedure allows for a viewer to easily see whether the transaction entry matches the product that was presented. In addition, the computer 104, or a computer in the security station 140, may recognize when a new object is presented to the scanner 122, and may not whether an object is presented without a corresponding transaction entry being made. Such a process does not require image recognition capable of determining what the object is, but only recognition capability sufficient to recognize when an object enters and leaves the scan zone 132.

When an anomaly occurs, such as a mismatch between the product that appears in the video stream and the product entered into the transaction, an employee at the security station 140 may intervene, directing a security employee to go to the station 102 and investigate the transaction. Alternatively, or in addition, particularly in cases in which the transaction is being conducted by an employee, a file of anomalies may be maintained, including records of captured images where a discrepancy is detected between the image of the item in the scan zone 132 and the product identified in a transaction entry, or the appearance of a product with out a corresponding transaction entry. The information thus collected can be used in investigation, in training, or to support disciplinary or legal action, depending on retailer policies and the nature of the events depicted.

In addition, or as an alternative, to directing video captured by the camera 134 to the security station 134, video can be directed anywhere desired. For example, the video stream may be displayed on an overhead screen 160. Such a display can have a significant deterrent effect against theft. The video stream can be stored for later review, and can even have a significant deterrent effect if it is not viewed or stored, particularly in the case of an employee, who can be instructed in detail about the presence and possible use of the video information, and will be aware that such information can be viewed, stored, or otherwise used without any specific notice to the employee that the information is being used at any particular time.

For example, suppose that an employee at a superstore wishes to cooperate with a confederate to allow theft by the confederate. The confederate takes a high priced product, such as a portable music player, and a lower priced product, such as a DVD, both of which have security tags affixed. The employee conceals the portable music player behind the DVD and scans the DVD. Scanning the DVD activates a security tag deactivator, which emits a magnetic field sufficient to deactivate security tags for both the DVD and the portable music player. The employee places both products into a bag, but has only scanned the DVD, so that only the DVD is entered into the transaction.

During this time, video from the camera 134 is being displayed at the security station 140. Images of the DVD and the music player appear on a screen 162 at the security station 140, and when the DVD is scanned, identification of the DVD, including an image, is retrieved and presented on the screen 162. The employee at the security station recognizes that not all of the products presented in the transaction were entered into the transaction, and issues a suitable alert.

Images or video taken by the camera 134 can be used in numerous other ways. For example, an employee at the checkout station 102, failing to recognize an item presented, can simply place the item in the field of view of the camera 134 and make a selection on the keyboard 116, requesting identification of the item and causing presentation of an image of the item at an identification station 164. An employee at the identification station 164 may have training to recognize items or may have a comprehensive collection of images and names, or may otherwise be equipped to provide quick and efficient identification. The identification station 164 need not be at the same location as the checkout station 102, but may be, if desired, at a central location serving a number of stores in a retail chain, and may communicate with the computer 104 and the server 126 over a wide area network such as the Internet 166.

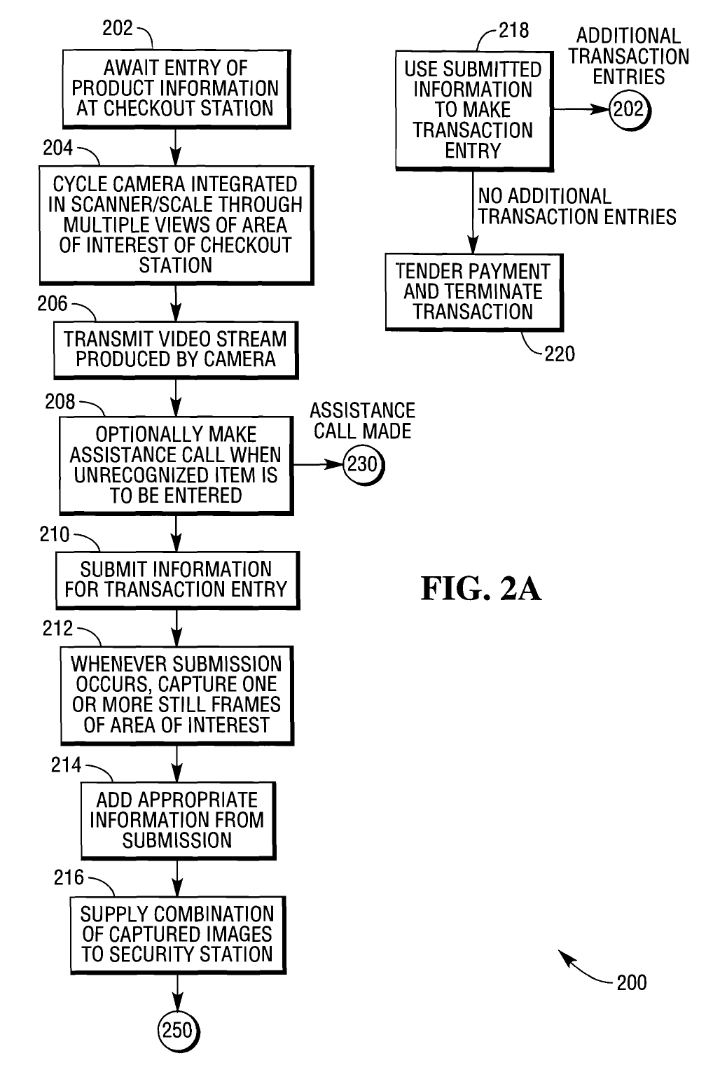

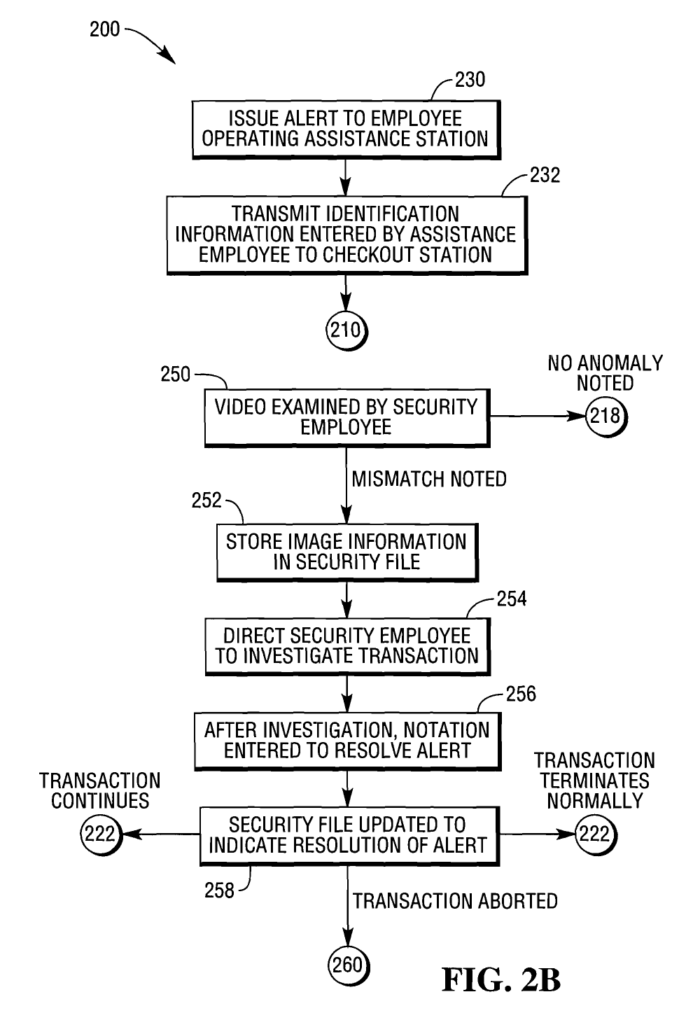

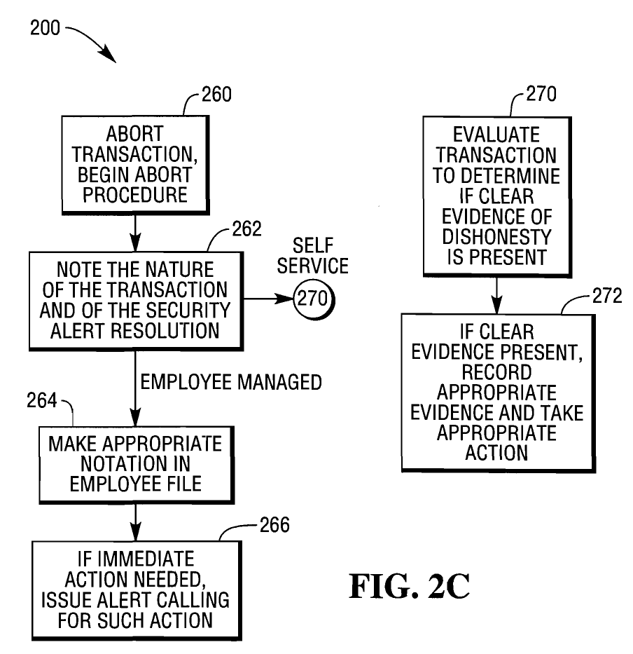

FIGS. 2A-2C illustrate the steps of a process 200 of checkout monitoring and assistance according to an aspect of the present invention. At step 202, entry of product information is awaited. At step 204, a camera, suitably integrated into a bar code scanner used for scanning product bar codes and other indicia for entry of product and other information into transactions, is continuously cycled through multiple views of an area of interest at a checkout station. The area of interest may suitably be a scan zone into which a product or other object is presented for reading of a bar code. The multiple views may be multiple field widths of the view taken by the camera, for example, a wide view including the scan zone and other objects and persons outside the scan zone, a medium view giving a closer view of objects within the scan zone but excluding some of the area outside the scan zone, and a narrow view giving a relatively close view of an object within the scan zone.

At step 206, a video stream produced by the camera is transmitted as desired, for example, to a security station, an overhead monitor, storage, or any other appropriate destination or combination of destinations. At optional step 208, occurring when a customer or checkout employee does not recognize the item presented, an assistance call is made and the process skips to step 230. At step 210, upon scanning of a product or other forms of information entry, product information is submitted for a transaction entry. At step 212, whenever a submission is made, such as by scanning a product bar code, a still frame or combination of still frames of the video stream are captured. At step 214, appropriate information from the submission, such as identification of the item entered into the transaction and an image of the item, is inserted into one or more of the still frames captured at the time the transaction entry is made. At step 216, the combination of captured images, that is, the image of the captured frame of the video stream with the inserted item information, is supplied to a security station. The process then skips to step 250 and a verification process is performed. As discussed further below, if the verification process reveals no anomalies, the process proceeds from step 250 to step 218, and an appropriate transaction entry is made. If additional transaction entries are to be made, the process returns to step 202. If no additional transaction entries are to be made, the process proceeds to step 220, payment is tendered, and the transaction terminates.

Step 230 begins the assistance procedure. In addition to recognizing and dealing with mismatches, visual images captured by an integrated camera may be supplied as needed for various functions, for example, providing customer or employee assistance. One such case is providing an image to a dedicated employee for identification of a product that is not immediately recognized by a customer or checkout employee. At step 230, upon issuance of an assistance call by an employee or customer who needs information about a product, such as identification of the product and furnishing of price information, an alert is issued to an assistance employee operating an assistance station. At step 232, upon observation by the assistance employee of the video produced by the camera, identification information entered by the employee is transmitted to the employee or customer at the checkout station. The process then proceeds to step 210.

Step 250 begins the verification process. At step 250, video associated with the transaction is examined by a security employee at a security station. If no anomaly is noted, the process proceeds to step 218.

If the security employee makes a notation indicating a mismatch between the object presented in the transaction and the object identified in the transaction, an alert procedure begins at step 252. At step 252, an entry is made storing the combined image in a special security file along with an indication of the nature of the mismatch. At step 254, a security employee near the checkout station is notified of the discrepancy and directed to investigate the transaction. At step 256, the investigating employee makes a suitable notation to resolve the alert. At step 258, the security file entry is updated to indicate the nature of the resolution.

Appropriate steps are then followed depending on the nature of the resolution. Upon an indication that a mismatch did not occur and a confirmation of the original transaction entry, or correction of a mismatch with correct transaction information, the process proceeds to step 214. If the employee clears the transaction entry and allows the transaction to proceed, the process returns to step 202 if additional transaction entries are to be made or proceeds to step 222 if no additional transaction entries are to be made.

If the nature of the resolution is such that the transaction should be terminated, for example, if the investigation indicates fraud or collusion, the process proceeds to step 260, the transaction is aborted, and an abort transaction procedure begins.

A transaction may be an employee serviced or a self service transaction, and the actions taken after resolution of a security alert may suitably vary based on the nature of the resolution of the alert and whether the transaction is employee serviced or self serviced. At step 262, the nature of the transaction and of the security alert resolution are noted. If the transaction is employee managed, the process proceeds to step 264. At step 264, depending on the nature of the resolution, an appropriate notation is made in an employee record. Examples of appropriate notations include an indication of an error indicating a need for training, an indication of possible dishonesty requiring monitoring or discipline, depending on whether the indication of possible dishonesty is clear-cut or merely suggestive, or an indication of a need for immediate action, such as immediate termination or suspension, or calling on law enforcement. If an indication of immediate action is made, the process proceeds to step 266 and an alert calling for such action is issued.

Returning now to step 262, if the transaction is self service, the process proceeds to step 270. In the case of a self service transaction, the option of making a notation in a record associated with the customer is not typically available. Therefore, at step 270, the transaction is evaluated to determine if clear evidence of dishonesty is present. If such evidence is present, the process proceeds to step 272, appropriate evidence is recorded and stored and appropriate enforcement action is taken, such as detaining the customer or summoning law enforcement.

During times when no mismatch is noted, the process proceeds normally, receiving transaction entries, capturing images, and otherwise operating to process transactions. When no mismatch is noted, any captured images may be discarded. For example, captured images may be discarded at appropriate times, for example, once the transaction has been completed normally at step 222. Because the mismatch resolution process involves storing images relevant to a mismatch, images that need to be kept will already have been stored separately by the time the originally captured images are to be discarded.

While the present invention is disclosed in the context of a presently preferred embodiment, it will be recognized that a wide variety of implementations may be employed by persons of ordinary skill in the art consistent with the above discussion and the claims which follow below.

We claim:

1. A checkout system, comprising:
a point of sale terminal for conducting checkout transactions, including receiving identification information for entering products into a transaction;
a scanner connected to and communicating with the point of sale terminal;
a camera integrated into the scanner, the camera capturing video of an area of interest with respect to the scanner; and
a video connection link for transmitting a video stream captured by the camera to one or more remote stations.

2. The system of claim 1, wherein the point of sale terminal is operative to transmit the video stream to a security station for monitoring to detect discrepancies between items entered into a transaction and items placed within the area of interest.

3. The system of claim 2, wherein one or more still frames of the video stream are captured when a transaction entry occurs.

4. The system of claim 3, further comprising a server hosting a product information database, wherein a transaction entry involves retrieval of product information relating to an identified product from the database, and wherein selected product information is integrated into the captured still frame to create a combined frame, the combined frame being transmitted to the security station for review.

5. The system of claim 4, wherein a combined frame is stored in a security file upon an indication of an anomaly.

6. The system of claim 5, wherein appropriate information relating to a transaction, including a combined frame, is stored in an employee record when an anomaly is detected in an employee managed checkout transaction.

7. The system of claim 1, wherein the video stream is directed to a remote product identification station upon request by a user of the checkout station, for identification of a product shown in the video stream.

8. A method of conducting checkout transactions, comprising:
capturing video of products presented within an area of interest, using a camera integrated into a scanner used at a checkout station;
using the video to prepare a video stream for transmission to a remote location for monitoring;
receiving product identification information for entry into transactions; and
transmitting the product identification information for a remote location for comparison with items appearing in the video stream.

9. The method of claim 8, further comprising a step of capturing one or more still frames of the video stream when a transaction entry occurs and transmitting the captured frames to the remote station.

10. The method of claim 9, further comprising a step of retrieving product information for a product to be entered into a transaction and adding selected product information to one or more of the captured frames to create a combined frame for transmission to the remote station.

11. The method of claim 8, wherein the remote location includes an overhead video display.

12. The method of claim 8, wherein the remote location is a security station and wherein selected video and transaction information is stored in a security file upon an indication of an anomaly by an employee operating the security station.

13. The method of claim 12, wherein selected transaction information, including a combined frame including integrated captured video and transaction information is stored in an employee file when an anomaly is detected in an employee managed transaction.

14. A method of identification of products, comprising:
capturing video of products placed within a field of view of a camera integrated into a scanner used at a checkout station;
upon receiving a selection by a user to request assisted identification, transmitting the video to a remote station operated by an identification assistance employee equipped to identify products for which transmitted video is received at the remote station;
receiving product identification information provided by the identification assistance employee and transmitting the product identification information to the checkout station.

15. The method of claim 14, wherein the remote station is at a central location serving a plurality of checkout stations at multiple retail sites.
